(19) United States
(12) Patent Application Publication
(10) Pub. No.: US 2001/0052114 A1
(43) Pub. Date: Dec. 13, 2001

(54) Data processing apparatus

(75) Inventors: Akihiko Koh, Kanagawa (JP); Tsutomu Sampei, Ibaraki (JP); Nobuhisa Watanabe, Kanagawa (JP); Akihiro Kikuchi, Chiba (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation

(21) Appl. No.: 09/802,857

(22) Filed: Mar. 12, 2001

(30) Foreign Application Priority Data
Mar. 14, 2000 (JP) P2000-076331

(51) Int. Cl. G06F 9/44

(52) U.S. Cl. 717/4

(57) ABSTRACT

A data processing apparatus which downloads a corrective program into its RAM during initial program loading, performs by its CPU interrupt processing in response to an interrupt request signal output from a debugging circuit when a program address coincides with a predetermined bug address, executes the debugged program, then reads program codes from the memory address next to the buggy part of a program to continue the processing after the interrupt processing. By executing the debugged program stored in the RAM as an interrupt processing routine instead of executing the buggy part of the program stored in the ROM, the buggy program is replaced by the bug-free corrected program and therefore the bug can be avoided.

### BACKGROUND OF THE INVENTION

1. Field of the Invention

The present invention relates to a data processing apparatus, for example, a data processing apparatus including at least a central processing unit (CPU) and a memory providing programs for the CPU, which is able to correct bugs in the programs stored in the memory after manufacture.

2. Description of the Related Art

In a conventional data processing apparatus, for example, in a microcomputer, a CPU having functions of operations and control, a memory storing programs, etc are integrated in a single semiconductor chip. When processing data, the CPU reads instruction codes sequentially from the memory according to addresses designated by a program counter and performs operations designated by the instruction codes. Therefore, the CPU can perform certain operations and processes according to a routine predetermined by the program.

Read only memories (ROM) are generally used as memories for storing programs for a CPU. The programs are written into the memories during manufacture, therefore are not rewritable after manufacture.

Programs, however, are produced at the same time as the devices they are applied to are developed. Many programs are produced while the devices are still unfinished. Further, after the devices are produced, modifications in their specifications sometimes causes part of the control programs produced up to then and stored in the microcomputers to no longer match with the devices. Further, in a large-scale system, the programs are also large in size, so it is difficult to find all the defects in the programs only by tests before production. In many cases the bugs in the programs are found after production.

When bugs are found after the production of a microcomputer, since the programs cannot be modified, the manufactured microcomputers cannot be used and become wasted and cause loss. Further, even if producing debugged programs and newly ordering and producing the microcomputers, there are drawbacks in cost and time.

To overcome these disadvantages, it has been proposed to include a function of correcting bugs in advance in a microcomputer. Namely, when finding a bug in a conventional microcomputer, it becomes possible to correct the bug even after manufacture by running a debugged program instead of running the buggy program. Below, an example of a microcomputer having this kind of debugging function will be illustrated, and the configuration and operations thereof will be explained.

FIG. 1 is a circuit diagram of an example of the configuration of a debuggable microcomputer. As illustrated, the microcomputer is made up of a CPU 10, a debugging circuit 20, a ROM 30, a serial input output (SIO) 40, a random access memory (RAM) 50, and a bus 60.

The CPU 10 performs predetermined operations and control in accordance with programs read from the ROM 30.

The debugging circuit 20, as illustrated in FIG. 2, is constituted by a bug address setting register 22, a coincidence detecting circuit 24, a branch instruction generating circuit 26, and a selecting circuit 28. When the microcomputer is initializing, the start address of the buggy part of the program (below referred to as the bug address) is read through the SIO 40 from an external memory and is set into the bug address setting register 22. When the program is run, the bug address and the program addresses input from the address bus ADRBUS are compared by the coincidence detecting circuit 24. A selecting control signal S_{c} is generated according to the comparison result and is output to the selecting circuit 28.

The branch instruction generating circuit 26 generates absolute branch instruction codes. When the CPU 10 executes an absolute branch instruction, the count of the program counter is set as the destination address designated by the absolute branch instruction, then the program code stored at this address is read and executed by the CPU 10.

The selecting circuit 28 selects one of the branch instruction code generated by the branch instruction generating circuit 26 or the program code read from the ROM 30 and outputs it to the data bus DATBUS. When the coincidence detecting circuit 24 judges a program address to be different from the bug address, the selecting control signal S_{c} is set to a logic “0”, for example, held at a low level. Accordingly, the selecting circuit 28 selects the program code read from the ROM 30 and outputs it to the data bus. On the other hand, when judging a program address to coincide with the bug address, the selecting control signal S_{c} is set to a logic “1”, for example, held at a high level. According to this, the selecting circuit 28 selects the branch instruction generated by the branch instruction generating circuit 26 and outputs it to the data bus. Namely, during normal operation, the CPU 10 reads program codes from the ROM 30 according to the program addresses and performs operations accordingly. When the program address reaches a bug address set previously, the debugging circuit 20 provides a branch instruction to the CPU 10, whereby the buggy program is not run, a debugged program stored in the addresses designated by the branch instruction is run, and therefore the bug is avoided.

The ROM 30 stores the programs of the CPU 10 and the data for processing. Note that the programs and the data are produced previously and written into the ROM 30 during the manufacture.

SIO 40 is a serial communication means transmitting data between the microcomputer and an external storage means, for example, the external memory 70. When the microcomputer is initializing, the start address and end address of the buggy program and the new program for replacing the old buggy program are read from the external memory 70 through the SIO 40. The read addresses and program are stored in a certain memory, for example, the RAM 50.

The RAM 50 stores the addresses and the program read from the external memory 70 through the SIO 40 when the microcomputer is initializing.

Generally, as shown in FIG. 1, the memory 70 storing the programs and the data for processing is provided outside of the microcomputer chip. The memory 70 stores the initialization program of the CPU 10, the debugged program, and the data for processing, for example, the initialization data for initializing the microcomputer and the parameters for certain data processing.

Below, an explanation will be given of the operation of the data processing apparatus illustrated in FIG. 1. At initialization, different kinds of data are read from the external memory 70 through the SIO 40. For example, the start address of the buggy part of the program stored in the ROM 30 (bug address), the end address, and the debugged program are read. The bug address is written into the bug address setting register 22 in the debugging circuit 20, while the debugged program is written into a predetermined area of the RAM 50. The branch instruction generating circuit 26 of the debugging circuit 20 generates a branch instruction code for branching to the head of the area storing the debugged program in the RAM 50.

After the initialization, the CPU 10 reads the program codes sequentially from the ROM 30 according to the program addresses generated by the program counter and executes the same. The debugging circuit 20 compares the program addresses and the bug address set in the bug address setting register 22 and outputs the selecting control signal S_{c} of the logic “0” until the program address reaches the bug address, therefore the selecting circuit 28 selects the program codes read from the ROM 30 and outputs them to the data bus. The CPU 10 reads and executes the program codes input from the data bus.

When a program address coincides with the bug address set in the bug address setting register 22, the debugging circuit 20 sets the selecting control signal S_{c} output from the coincidence detecting circuit 24 to the logic “1”. According to this, the branch instruction and the code of the branch destination generated by the branch instruction generating circuit 26 are selected by the selecting circuit 28 and output to the data bus. Since the branch instruction and the code of the branch destination are input from the data bus and executed by the CPU 10, the count of the program counter is set to the address of the branch destination, for example, the start address of the area storing the debugged program in the RAM 50. Accordingly, from the next operation cycle, the codes of the debugged program stored in the RAM 50 are output to the data bus sequentially, read by the CPU 10, and executed.

An absolute branch instruction for branching to the address next to the last address of buggy part of the program stored in the ROM 30 is written at the end of the debugged program, so when the CPU 10 executes this branch instruction, the count of the program counter is rewritten to the address next to the end address of the buggy part of the program stored in the ROM 30. From the next operation cycle, the program codes are read sequentially from this address and executed by the CPU 10.

Due to the operation described above, the buggy part of a program stored in the ROM 30 can be avoided and a debugged program executed. After the execution of the debugged program, the program counter returns to the memory address next to the end of the buggy part in the ROM 30 and the processing can be continued.

In the conventional microcomputer described above, however, the debugging circuit includes not only the bug address setting register and the coincidence detecting circuit, but also the branch instruction generating circuit and the selecting circuit. Therefore, the configuration of the circuit becomes complicated and the size of the circuit increases due to the incorporation of the debugging circuit. Particularly, when there are several bugs in the program stored in the ROM, in order to avoid each bug, it is necessary to provide several basic units comprised of bug address setting registers, coincidence detecting circuits, branch instruction generating circuits, and selecting circuits. This has the further drawback that the debugging circuit becomes larger in size.

Further, the method of using a flash memory capable of being electrically rewritten rather than a ROM as the memory storing programs for microcomputers has been proposed, but the price of a microcomputer chip using a flash memory is generally higher than one using a ROM. Further, programs cannot be written into a flash memory during manufacture. They must be written into each chip through writing operations after manufacture. Accordingly, the manufacturing time is long and an increase of cost is caused, so this is not suitable for mass production.

### SUMMARY OF THE INVENTION

An object of the present invention is to provide a data processing apparatus capable of avoiding a bug in a built-in program by executing a debugged program rather than the buggy program without greatly increasing the size of the circuit and while keeping down the increase of the production cost.

To attain the above object, according to a first aspect of the invention, there is provided a data processing apparatus performing predetermined data processing in accordance with instruction codes read from a memory storing a program, comprising an address holding means for holding a bug address showing the start of a buggy part of the program stored in the memory, a comparison means for comparing a program address for reading the program from the memory with the bug address held in the address holding means during the data processing and outputting a coincidence signal when the addresses coincide, and a program executing means for performing predetermined data processing in accordance with instruction codes read from the memory when the coincidence signal is not output by the comparison means and for suspending an instruction being executed, reading instruction codes from a program address designated by a predetermined address table, and performing processing according to the read instruction codes when the coincidence signal is output by the comparison means.

Preferably the comparison means comprises an interrupt request means for outputting an interrupt request signal as the coincidence signal when a program address coincides with the bug address held in the address holding means.

Preferably, the apparatus further comprises a rewritable memory for storing a debugging program input from the outside during initialization and an interrupt vector for storing a start address of a memory area storing the debugged program.

Preferably, the program executing means comprises an interrupt processing means for suspending an instruction being executed when receiving the interrupt request signal, reading the debugging program from the address designated by the interrupt vector, and performing processing accordingly.

Preferably, the interrupt processing means sets a return address for returning to the suspended program after the interrupt processing according to an address stored at the end of the debugging program after execution of the debugging program.

According to a second aspect of the invention, there is provided a data processing apparatus performing predetermined data processing in accordance with instruction codes read from a memory storing a program, comprising a plurality of basic units each including an address holding means for holding a bug address showing the start of a buggy part of the program stored in the memory and a comparison means for comparing a program address for reading the program from the memory with the bug address held in the address holding means during the data processing and outputting a coincidence signal when the addresses coincide, the number of basic units corresponding to the number of bugs included in the program, and a program executing means for performing predetermined data processing in accordance with instruction codes read from the memory when the coincidence signal is not output by the comparison means and for suspending an instruction being executed, reading instruction codes from a program address designated by a predetermined address table, and performing processing according to the read instruction codes when the coincidence signal is output by any one of the comparison means.

Preferably, the apparatus further comprises a writeable memory for storing a debugging program input from the outside during initialization, and an interrupt vector for storing the start address of a memory area storing the debugging program.

Preferably, the interrupt processing means comprises an interruption recording means for recording the number of interruptions, a branch means for branching to a predetermined debugging program among a plurality of the debugging programs stored in the memory according to the number of interruptions recorded by the interruption times recording means.

Preferably, an address to be returned to when returning to the original program when the debugging program is finished is stored at the end of each debugging program, and the interrupt processing means sets a return address for returning to the original program after the execution of any of the debugging programs according to the return address stored at the end of the debugging program.

According to the present invention, a bug address holding means, for example, the bug address setting register, and a comparison means for comparing the bug address and a program address are provided in the data processing apparatus. When a bug is found in a program, the start address of the buggy part of the program is stored in the bug address holding means. When the program is being executed, the program addresses and the bug address held in the bug address holding means are compared by the comparison means. A coincidence signal is generated when a program address coincides with the bug address. Accordingly, the program executing means, for example, the CPU, suspends the program being executed and reads and executes the debugged program from a program address designated by a predetermined address table. Therefore, a buggy program can be avoided.

Because the return address for returning to the original program is set at the end of the debugged program, the program executing means can continue processing from the part of the program after the buggy part by branching to the return address.

### BRIEF DESCRIPTION OF THE DRAWINGS

These and other objects and features of the present invention will become clearer from the following description of the preferred embodiments given with reference to the accompanying drawings, in which:

FIG. 1 is a block diagram of an example of a conventional data processing apparatus;

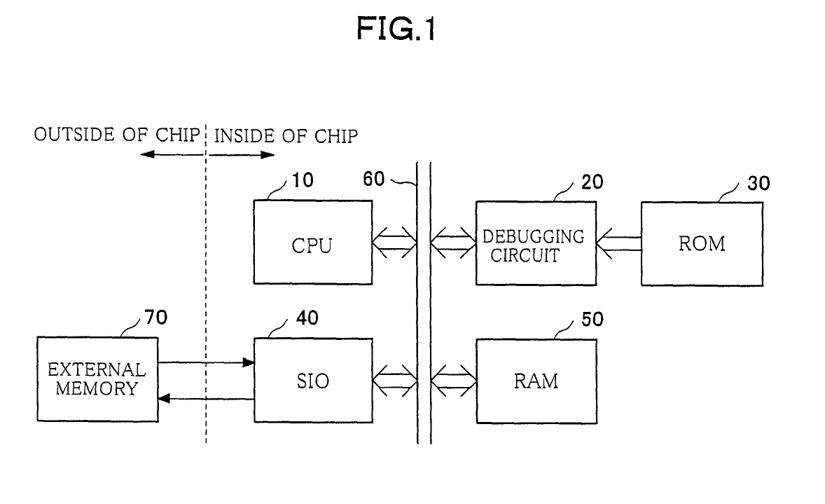

FIG. 2 is a block diagram of the configuration of a debugging circuit of the conventional data processing apparatus;

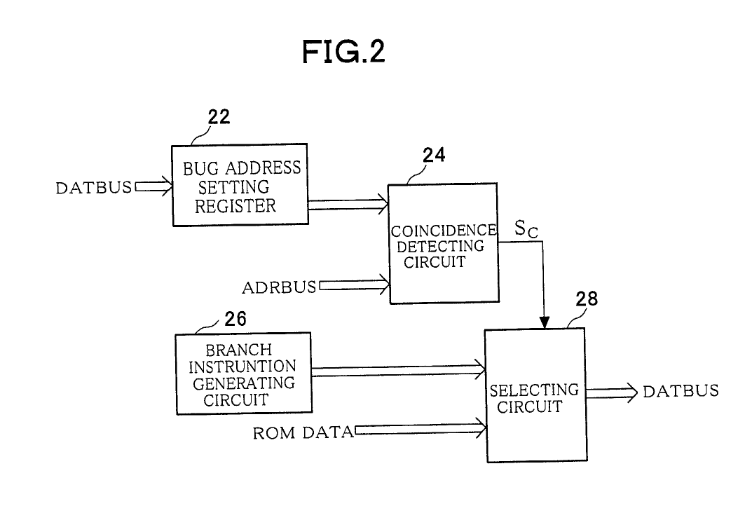

FIG. 3 is block diagram of a first embodiment of the data processing apparatus according to the present invention;

FIG. 4 is a block diagram of the configuration of a debugging circuit of the data processing apparatus according to the present embodiment;

FIG. 5 is a view of the content of the memory in the data processing apparatus according to the present embodiment;

FIG. 6 is a flow chart of the operation of the data processing apparatus of the present embodiment; and

FIG. 7 is block diagram of a second embodiment of the data processing apparatus according to the present invention and showing the configuration of the debugging circuit.

### DESCRIPTION OF THE PREFERRED EMBODIMENTS

First Embodiment

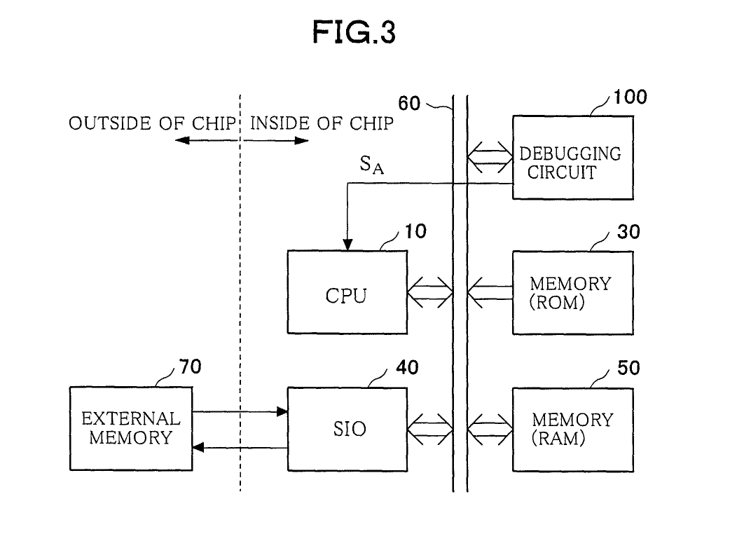

FIG. 3 is a circuit diagram of a first embodiment of a data processing apparatus according to the present invention. As illustrated, the data processing apparatus of the present embodiment is constituted by a CPU 10, a memory (ROM) 30, a serial interface (SIO) 40, a memory (RAM) 50, buses (including a data bus and an address bus) 60, and a debugging circuit 100. Generally, these circuits and buses are integrated in a single semiconductor chip and constitute a so-called one-chip microcomputer.

Below, an explanation of the configuration of each circuit will be given.

The CPU 10 reads instruction codes from the ROM 30 according to a not illustrated program counter and performs operations and other processing accordingly. Further, the CPU 10 is provided with an interrupt processing function performing a predetermined interrupt processing in response to an interrupt request signal SA from the outside.

In the present invention, the buggy program is processed utilizing the interrupt processing function of the CPU 10. Note that, the interrupt processing function is utilized for immediately processing in response to a request signal input from the outside during the execution of a normal program. Generally, plural interruptions processable by the CPU 10 are assigned to each external interrupt request. For this reason, by utilizing an interrupt processing not utilized in the normal processing, for example, the abort interruption provided for testing the microcomputer, the debugged program is able to be executed without affecting the normal interrupt processing.

The ROM 30 stores the programs for the CPU 10 and data for processing. The storage data of the ROM 30 is written into the ROM 30 during manufacture and can only be read, not rewritten.

The SIO 40 is a serial communication means for transmitting data between the microcomputer and a storage means provided outside of the microcomputer, for example, an external memory 70. In general, when the microcomputer is initialized, the start address and end address of the buggy part in a program stored in the ROM 30 and the debugged program are read from the external memory 70 through the SIO 40. The read addresses and the program are then stored in a certain part, for example, the RAM 50.

The RAM 50 stores the addresses and the debugged program read from the external memory 70 through the SIO 40 when the microcomputer is initialized.

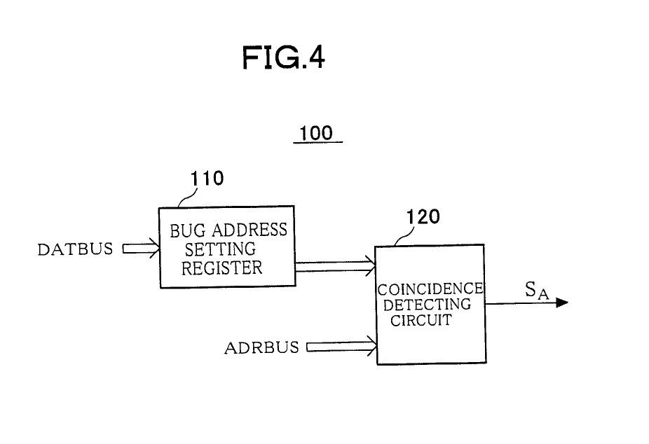

The debugging circuit 100 compares a predetermined bug address with a program address executed by the CPU 10 and generates the interrupt request signal for the CPU 10 according to the result of the comparison. Below, a detailed explanation will be given of the configuration of the debugging circuit 100 by referring to FIG. 4.

As illustrated, the debugging circuit 100 is constituted by a bug address setting register 110 and a coincidence detecting circuit 120. As described above, during initialization, the start address of the buggy part of the program (below, referred to as a bug address) is read from the external memory 70 through the SIO 40. The bug address is output to the data bus DATBUS and written into the bug address setting register 110 through the data bus.

When the CPU 10 is executing the program, the count of the program counter is output to the address bus ADRBUS as the program address. The coincidence detecting circuit 120 compares the program address input from the address bus with the bug address set in the bug address setting register 110 and generates the interrupt request signal S_{A} according to the result of the comparison. For example, when a program address does not coincide with the bug address, the interrupt request signal S_{A} is held at a high level, while when the program address coincides with the bug address, the interrupt request signal S_{A} is held at a low level. The CPU 10 carries out the interrupt processing upon receiving the interrupt request signal SA from the coincidence detecting circuit 120. For example, at the trailing edge of the interrupt request signal S_{A}, an interrupt request is generated for the CPU 10. The CPU 10 performs the interrupt processing after the end of the operation cycle of the instruction code being executed. That is, the coincidence of the program address with the predetermined bug address is detected by the coincidence detecting circuit 120, then the interrupt request signal S_{A} is held at the low level accordingly. The CPU 10 responds to the interrupt request at the trailing edge of the interrupt request signal S_{A}, suspends the program being executed, and carries out the interrupt processing.

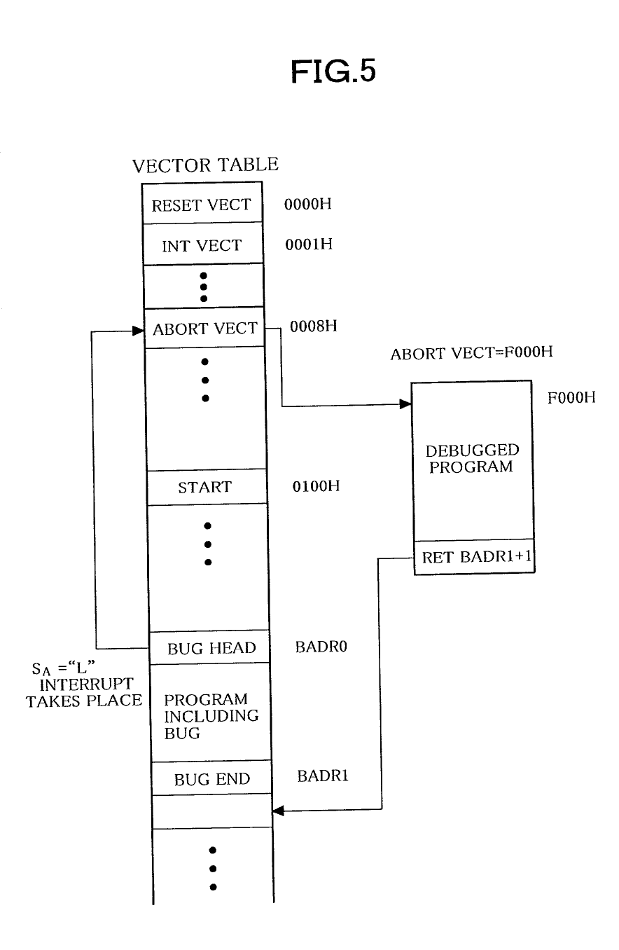

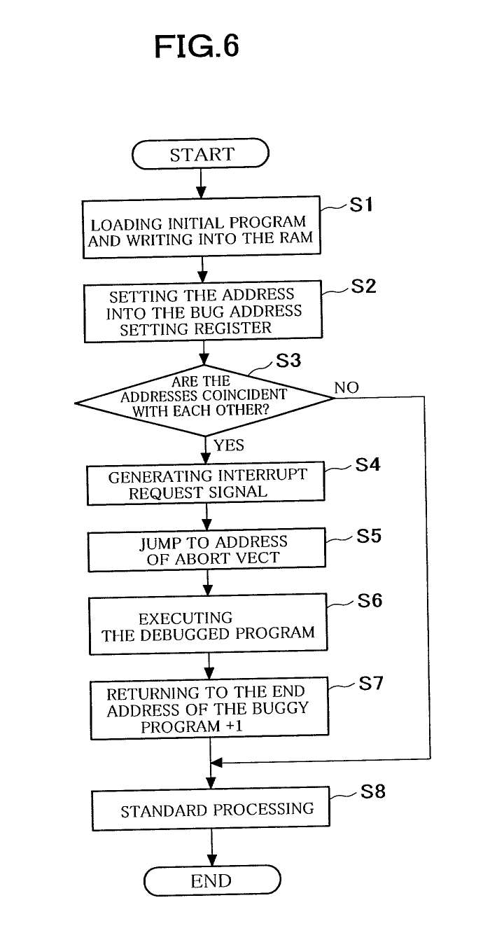

FIG. 5 is a view of the layout showing the content of the memory of the data processing apparatus of the present embodiment, while FIG. 6 is a flow chart showing the operations of the present embodiment. Below, an explanation will be given of the operations of the present embodiment while referring to FIG. 5 and FIG. 6.

After the data processing apparatus starts the operation, first the initialization processing as shown in step S1 is carried out. At this time, the data processing apparatus reads the initialization program (initial program) stored in the external memory 70 through the SIO 40 and stores the same to a predetermined area in the RAM 50. Further, in this initialization processing, the start address of the buggy part of the program stored in the ROM 30, namely, the bug address, is read and set into the bug address setting register 110 of the debugging circuit (step S2).

By the initialization processing, for example, the initialization data is stored in a certain area in the RAM 50. As shown in FIG. 5, for example, the reset vector (RESET VECT), the interrupt vector (INT VECT), and the abort vector (ABORT VECT) are stored from the address 0000H in the RAM 50. Note that the abort vector is an address showing the destination of the branching for the CPU 10 when an interrupt request signal S_{A} at the low level is output from the coincidence detecting circuit 120 of the debugging circuit 100.

After the initialization processing, the program stored in the ROM 30 is read sequentially and executed. For example, as shown in FIG. 5, the program from the address 0100H is the program stored in the ROM 30. When there is a bug in the part from the bug address BADR0 to the end address BADR1 in this program, by the initialization processing described above, the address BADR0 is written into the bug address setting register 110 of the debugging circuit 100 as the bug address.

Each time the program address output to the address bus is renewed, the debugging circuit 100 compares the program address with the bug address (step S3). When a program address does not coincide with the bug address, the interrupt request signal S_{A} is held at the high level, and the CPU 10 performs the normal processing. Namely, the CPU 10 reads the next program code from the address of the ROM 30 designated by the program counter and performs processing accordingly.

When a program address coincides with the bug address, namely, as shown in the memory layout in FIG. 5, when a program address reaches the start address BARD0 of the buggy part of the program, an interrupt request signal S_{A} at the low level is output from the coincidence detecting circuit 120 of the debugging circuit 100 (step S4). Upon receiving the same, an interrupt occurs and, as shown in FIG. 5, the vector stored in the abort vector (ABORT VECT), for example, the address F000H, is set in the program counter (step S5).

Consequently, from the next operation cycle, the CPU 10 executes the interrupt processing routine. In the example shown in FIG. 5, the interrupt processing routine is stored in the memory area from the address F000H designated by the abort vector. Note that, the memory area is in the RAM 50. The program stored there is read from the external memory 70 through the SIO 40 and stored in the RAM 50 during the initialization processing.

In the interrupt processing, the CPU 10 reads the instruction codes sequentially from the memory address designated by the program address output to the address bus and executes the same (step S6). Namely, as shown in FIG. 5, the debugged program stored in the area from the memory address F000H in the RAM 50 is read sequentially and executed. At the end of the program, an instruction code showing the return address for after the interrupt processing (for example, in the example of FIG. 5, “RET BADR+1”) is stored. Upon reading this instruction code, the CPU 10 finishes the interrupt processing, then sets the return address “BADR+1” in the program counter (step S7).

As shown in FIG. 5, “BADR1” is the end address of the buggy part of the program stored in the ROM 30. For this reason, by setting “BADR+1” in the CPU 10 as the return address, after the interrupt processing, the CPU 10 reads the program codes from the code next to the buggy part of the program to continue the processing.

As described above, when a program address coincides with a bug address set previously, the CPU 10 carries out the interrupt processing, then after the interrupt processing, reads the program codes from the memory address next to the buggy part of the program to continue the processing. Accordingly, the buggy part of the program stored in the ROM 30 is not executed. Instead, the debugged program stored in the RAM 50 as an interrupt processing routine is executed. Therefore, the buggy program is avoided.

In the present embodiment, the buggy part of the program can be avoided by utilizing the interrupt functions provided in almost all kinds of data processing apparatuses such as microcomputers. Generally, a microcomputer can process a plurality of interruptions having different priority levels. By selecting an appropriate one from these interrupt processes, the buggy part of the program can be avoided without affecting the normal processing. For example, some microcomputers are provided with abort functions for aborting a program being executed during a test, then restarting the execution afterward. In this kind of microcomputer, the abort function is seldom utilized at times other than tests. It is possible to utilize this function, as shown in FIG. 5, to store the start address of the debugged program as the abort vector (ABORT VECT), cause an abort interrupt when a program address reaches the bug address during execution of the program, and execute the interrupt processing routine, that is, the debugged program, to avoid the buggy part of a program.

For this reason, in the data processing apparatus of the present embodiment, the configuration of the debugging circuit 100 is simplified comparing with the conventional ones. It is able to be constituted only by the bug address setting register 110 for storing the bug address and the coincidence detecting circuit 120 for comparing the addresses. Furthermore, the operation delay due to the gate delay of the selecting circuit can be avoided since the program address does not go through the selecting circuit like in the conventional debugging circuit.

Furthermore, in the data processing circuit of the present embodiment, it is possible to handle a plurality of bugs in a program of the ROM 30 by providing the debugging circuit 100 with a number of sets of bug address setting registers 110 and coincidence detecting circuits 120 equal to the number of the bugs. Below, a second embodiment of the data processing apparatus of the present invention which is able to process a plurality of bugs will be explained.

Second Embodiment

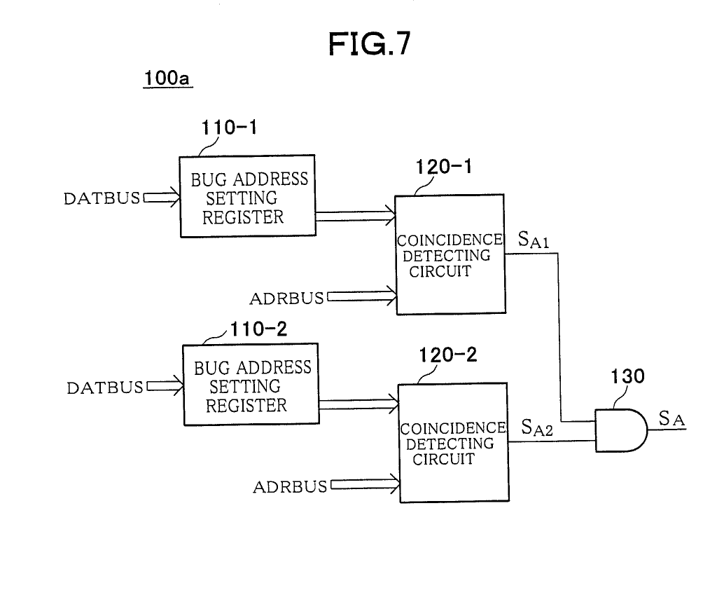

FIG. 7 is a circuit diagram of a second embodiment of the data processing apparatus according to the present invention. In the data processing apparatus of the present embodiment, the parts other than the debugging circuit are substantially the same as those in the first embodiment. Therefore, in FIG. 7, only the debugging circuit 100a of the data processing apparatus of the present embodiment is illustrated. Here, for example, there are two bugs found in the program in the ROM 30. Debugged programs for each bug are produced and loaded into the RAM 50 by the initialization processing.

As shown in FIG. 7, the debugging circuit 100a is constituted by bug address setting registers 110-1 and 110-2 and coincidence detecting circuits 120-1 and 120-2. By the initialization processing, a first bug address BADR0-1 is stored in the bug address setting register 110-1, while a second bug address BADR0-2 is stored in the bug address setting register 110-2.

The coincidence detecting circuits 120-1 and 120-2 compare the two bug addresses with a program address. When addresses coincide, they output low level signals SA1 and SA2, respectively.

When there is sufficient leeway in the interrupt processing of the CPU 10, the output signals SA1 and SA2 of the coincidence detecting circuits 120-1 and 120-2 can be input to the CPU 10 as two different interrupt request signals. Accordingly, the CPU 10 receives these as different interrupt requests and executes the debugged programs separately to correct the two bugs. In general, however, the number of the interruptions that the CPU 10 is able to process is limited, so a plurality of bug processings have to be assigned to a single interruption. In this case, as shown in FIG. 7, the output signals SA1 and SA2 of the coincidence detecting circuits 120-1 and 120-2 are input to an AND gate 130, and the output signal S_{A} Of the AND gate 130 is input to the CPU 10 as the interrupt request signal.

When the CPU 10 executes a program and a program address coincides with any of the bug addresses, the output signal of the coincidence detecting circuit 120-1 or 120-2 is set to the low level and the output signal S_{A} of the AND gate 130 becomes the low level. Accordingly, the interrupt request is generated for the CPU 10. Therefore, the CPU 10 executes the program of the interrupt processing routine designated by the abort vector.

Here, in order to execute a plurality of debugged programs in an appropriate order, a branch processing program is provided at the start of the interrupt processing routine for branching to each debugged program. For example, a predetermined memory address is assigned as a counter register in the RAM 50. At the initialization, the counter register is cleared (is set to 0). Each time an interrupt routine is executed, the counter register is increased by 1. The CPU 10 is able to judge the number of times of interrupt, that is, which number bug is being corrected, by the value of the counter register. Therefore, the CPU 10 is able to branch to the correct debugged program accordingly, read the program code, and perform the predetermined processing.

According to the second embodiment of the present invention described above, when a plurality of bugs are found in a program, the same number of sets of bug address setting registers and coincidence detecting circuits as the number of the bugs are provided in the debugging circuit 100a. An interrupt request signal S_{A} is generated by the logic gate and input to the CPU 10 according to the output signals from the plurality of the coincidence detecting circuits. Upon receiving an interrupt request, the CPU 10 reads the program codes from the interrupt processing routine designated by the interrupt vector and executes the same. At the beginning of the interrupt processing routine, since the number of bugs that is being corrected can be judged according to the value of the counter register counting the number of the interrupt processings, the CPU 10 is able to branch to the correct destination among a plurality of the debugged programs.

In the present embodiment, since the basic unit of the debugging circuit 100a is simple in configuration, that is, is formed by the bug address setting register and the coincidence detecting circuit, when correcting a plurality of bugs, the configuration of the debugging circuit 100a is able to be limited to a small size even though a plurality of units are provided. Further, a plurality of the debugging processes can be assigned to a single interrupt processing routine, and the branch process for the plurality of the debugged programs can be realized by software. Therefore the increase of the hardware is able to be limited to a minimum amount needed. Further, since the interrupt processing routines are read from the external memory and loaded to the RAM during the initialization, the modification of the program can be realized simply, and it is possible to flexibly handle cases where a plurality of bugs are found.

The data processing apparatus of the present invention is able to correct the bugs as described above. Note that, the present invention can be applied not only for correcting bugs included in programs, but also for correcting bugs included in the data area. In this case, the address of the buggy data, that is, the error data, is set into the bug address setting register. When the CPU tries to read the error data, an interrupt request is generated by the coincidence detecting circuit and the CPU obtains the correct data in an interrupt processing routine.

Summarizing the effects of the invention, as described above, according to the data processing apparatus of the present invention, when a bug is found in a program stored in the ROM after the manufacturing, it is able to correct the bug without having to remake the chips. The debugged program is loaded into the RAM during the initialization of the data processing apparatus. During the execution of the program, an interrupt request is generated when a program address coincides with the bug address. By utilizing the interrupt processing functions of the CPU, the debugged program is executed and the buggy part of the program can be avoided. Therefore, the hardware configuration of the debugging circuit can be simplified and the cost increase due to the provision of the debugging function can be limited to a minimum amount.

Further, when correcting a plurality of the bugs, there is a merit that the branch processing to the plurality of the debugged programs loaded in the RAM can be realized by software, therefore the increase of the hardware can be limited to the minimum amount needed.

What is claimed is:

1. A data processing apparatus performing predetermined data processing in accordance with instruction codes read from a memory storing a program, comprising
an address holding means for holding a bug address showing the start of a buggy part of the program stored in the memory,
a comparison means for comparing a program address for reading the program from the memory with the bug address held in the address holding means during the data processing and outputting a coincidence signal when the addresses coincide, and
a program executing means for performing predetermined data processing in accordance with instruction codes read from the memory when said coincidence signal is not output by said comparison means and for suspending an instruction being executed, reading instruction codes from a program address designated by a predetermined address table, and performing processing according to the read instruction codes when said coincidence signal is output by said comparison means.

2. A data processing apparatus as set forth in claim 1, wherein said comparison means comprises an interrupt request means for outputting an interrupt request signal as said coincidence signal when a program address coincides with the bug address held in the address holding means.

3. A data processing apparatus as set forth in claim 2, wherein the apparatus further comprises
a rewritable memory for storing a debugging program input from the outside during initialization and
an interrupt vector for storing a start address of a memory area storing said debugged program.

4. A data processing apparatus as set forth in claim 3, wherein said program executing means comprises an interrupt processing means for suspending an instruction being executed when receiving said interrupt request signal, reading said debugging program from the address designated by said interrupt vector, and performing processing accordingly.

5. A data processing apparatus as set forth in claim 4, wherein said interrupt processing means sets a return address for returning to the suspended program after the interrupt processing according to an address stored at the end of said debugging program after execution of said debugging program.

6. A data processing apparatus performing predetermined data processing in accordance with instruction codes read from a memory storing a program, comprising
a plurality of basic units each including
an address holding means for holding a bug address showing the start of a buggy part of the program stored in the memory and
a comparison means for comparing a program address for reading the program from the memory with the bug address held in the address holding means during the data processing and outputting a coincidence signal when the addresses coincide,
the number of basic units corresponding to the number of bugs included in the program, and
a program executing means for performing predetermined data processing in accordance with instruction codes read from the memory when said coincidence signal is not output by said comparison means and for suspending an instruction being executed, reading instruction codes from a program address designated by a predetermined address table, and performing processing according to the read instruction codes when said coincidence signal is output by any one of said comparison means.

7. A data processing apparatus as set forth in claim 6, wherein said comparison means comprises an interrupt request means for outputting an interrupt request signal as said coincidence signal when a program address coincides with the bug address held in the address holding means.

8. A data processing apparatus as set forth in claim 7, further comprising
a writeable memory for storing a debugging program input from the outside during initialization and
an interrupt vector for storing the start address of a memory area storing said debugging program.

9. A data processing apparatus as set forth in claim 8, wherein said program executing means comprises an interrupt processing means for suspending an instruction being executed when receiving said interrupt request signal, reading said debugging program from the address designated by said interrupt vector, and performing processing accordingly.

10. A data processing apparatus as set forth in claim 9, wherein said interrupt processing means comprises
an interruption recording means for recording the number of interruptions and
a branch means for branching to a predetermined debugging program among a plurality of the debugging programs stored in the memory according to the number of interruptions recorded by the interruption times recording means.

11. A data processing apparatus as set forth in claim 9, wherein an address to be returned to when returning to the original program when the debugging program is finished is stored at the end of each debugging program, and said interrupt processing means sets a return address for returning to the original program after the execution of any of the debugging programs according to the return address stored at the end of the debugging program.

12. A data processing apparatus as set forth in claim 10, wherein said interruption recording means is a memory of a predetermined address in the rewritable memory storing the debugging programs and wherein the content of the memory is rewritten by said interrupt processing means.
